(19) United States
(12) Patent Application Publication
(10) Pub. No.: US 2004/0162115 A1
(43) Pub. Date: Aug. 19, 2004

(54) Wireless antennas, networks, methods, software, and services

(76) Inventors: Martin Smith, Chelmsford (GB); Chris Ward, Bishops Stortford (GB); David Bevan, Bishops Stortford (GB); Koon Hoo Teo, Nepean (CA); Adrian Smith, Kanata (CA)

Correspondence Address: BARNES & THORNBURG, P.O. BOX 2786, CHICAGO, IL, 60690-2786, US

(21) Appl. No.: 10/683,408

(22) Filed: Oct. 10, 2003

Related U.S. Application Data
(60) Provisional application No. 60/447,645, filed on Feb. 14, 2003.

(51) Int. Cl. H04M 1/00; H04B 1/38

(52) U.S. Cl. 455/562.1; 455/561

(57) ABSTRACT

The invention is directed to a wireless network arrangement in which nodes comprise multi-faceted multi-beam antennas and in which wireless backhaul is provided using those multi-faceted multi-beam antennas. In particular, the invention is directed to a wireless communication node comprising: an antenna defining a first wireless coverage area and a second wireless coverage area. The first wireless coverage area extends in a first beam pattern and the second wireless coverage area extends in a second beam pattern and the second beam pattern comprises at least one directional beam having a direction which is variable. Associated apparatus, methods, programs, and subscriber services are also provided.

### RELATED APPLICATION

This application is the full utility filing of U.S. provisional application No. 60/447,645 filed on Feb. 14, 2003, from which the present application claims priority and which is incorporated herein by reference.

### CROSS-REFERENCE TO RELATED APPLICATIONS

This patent application is related to the following Provisional patent applications filed in the U.S. Patent and Trademark Office, the disclosures of which are expressly incorporated herein by reference:

U.S. Patent Application Serial No. 60/446,617 filed on Feb. 11, 2003 and entitled “System for Coordination of Multi Beam Transit Radio Links for a Distributed Wireless Access System” [15741]

U.S. Patent Application Serial No. 60/446,618 filed on Feb. 11, 2003 and entitled “Rendezvous Coordination of Beamed Transit Radio Links for a Distributed Multi-Hop Wireless Access System” [15743]

U.S. Patent Application Serial No. 60/446,619 filed on Feb. 11, 2003 and entitled “Distributed Multi-Beam Wireless System Capable of Node Discovery, Rediscovery and Interference Mitigation” [15742]

U.S. Patent Application Serial No. 60/447,527 filed on Feb. 14, 2003 and entitled “Cylindrical Multibeam Planar Antenna Structure and Method of Fabrication” [15907]

U.S. Patent Application Serial No. 60/447,643 filed on Feb. 14, 2003 and entitled “An Omni-Directional Antenna” [15908]

U.S. Patent Application Serial No. 60/447,644 filed on Feb. 14, 2003 and entitles “Antenna Diversity” [15913]

U.S. Patent Application Serial No. 60/447,646 filed on Feb. 14, 2003 and entitled “Wireless Communication” [15897]

U.S. Patent Application Serial No. 60/451,897 filed on Mar. 4, 2003 and entitled “Offsetting Patch Antennas on an Omni-Directional Multi-Facetted Array to allow Space for an Interconnection Board” [15958]

U.S. Patent Application Serial No. 60/453,011 filed on Mar. 7, 2003 and entitled “Method to Enhance Link Range in a Distributed Multi-hop Wireless Network using Self-Configurable Antenna” [15946]

U.S. Patent Application Serial No. 60/453,840 filed on Mar. 11, 2003 and entitled “Operation and Control of a High Gain Phased Array Antenna in a Distributed Wireless Network” [15950]

U.S. Patent Application Serial No. 60/454,715 filed on Mar. 15, 2003 and entitled “A Method to Efficiently Search for Neighbours using a Directive Antenna System in a Distributed Wireless Network” [15952]

U.S. Patent Application Serial No. 60/461,344 filed on Apr. 9, 2003 and entitled “Method of Assessing Indoor-Outdoor Location of Wireless Access Node” [15953]

U.S. Patent Application Serial No. 60/461,579 filed on Apr. 9, 2003 and entitled “Minimisation of Radio Resource Usage in Multi-Hop Networks with Multiple Routings” [15930]

U.S. Patent Application Serial No. 60/464,844 filed on Apr. 23, 2003 and entitled “Improving IP QoS though Host-Based Constrained Routing in Mobile Environments” [15807]

U.S. Patent Application Serial No. 60/467,432 filed on May 2, 2003 and entitled “A Method for Path Discovery and Selection in Ad Hoc Wireless Networks” [15951]

U.S. Patent Application Serial No. 60/468,456 filed on May 7, 2003 and entitled “A Method for the Self-Selection of Radio Frequency Channels to Reduce Co-Channel and Adjacent Channel Interference in a Wireless Distributed Network” [16101]

U.S. Patent Application Serial No. 60/480,599 filed on Jun. 20, 2003 and entitled “Channel Selection” [16146]

### FIELD OF THE INVENTION

The present invention relates to methods, apparatus, and software for wireless communications systems and systems incorporating the same.

### BACKGROUND TO THE INVENTION

It is known to construct wireless networks comprising multiple wireless access nodes linked by wireless connections to form a distributed wireless backhaul network. Deployment of such networks is a costly process and there is a very strong incentive to network builders and operators to minimise installation time and hence installation costs. Nevertheless, known systems involve time-consuming orientation and configuration processes.

Known systems employ omni-directional antennas to provide the backhaul connectivity between the access nodes. However, such arrangements exhibit both limited backhaul range between nodes and limited capacity. Providing a means to increase at least one of either the range or capacity of the backhaul links would offer clear technical and commercial advantage through, for example, reducing the number of nodes necessary to provide similar coverage.

Known system also share a transmission band between the access paths and the backhaul paths. This means that, in simple terms, each active access channel requires a further channel to be allocated from the same band to a corresponding backhaul link.

A further problem with known wireless backhaul system employing omni-directional nodes is the forwarding problem in which a transmitting node prevents neighbouring nodes from transmitting due to contention for the channel (as, for example, with IEEE 802.11, RTS/CTS, etc.). Nodes forwarding backhaul traffic must allocate further channels from the shared band to carry the forwarded traffic thereby further depleting the number of channels available for access use.

### OBJECT OF THE INVENTION

The invention seeks to provide an improved method and apparatus for wireless communications systems.

### SUMMARY OF THE INVENTION

According to a first aspect of the present invention there is provided a wireless communication node comprising: an antenna defining a first wireless coverage area and a second wireless coverage area, wherein the first wireless coverage area extends in a first beam pattern and the second wireless coverage area extends in a second beam pattern, and wherein said second beam pattern comprises at least one directional beam having a direction which is variable.

The direction may be variable by means of one of beam switching and beam steering.

The first coverage area may provide at least one wireless link and said second coverage area may provide at least one wireless link.

The first coverage area may provide at least one access link and said second coverage area may provide at least one backhaul link.

Advantageously, whilst using an omni-directional antenna for backhaul is possible, the use of beams improves gain and range.

The node may further comprise: a first radio for communication over said first coverage area; and a second radio for communication over said second coverage area.

The node may further comprise: a radio for communication over both said first and said second coverage areas.

Advantageously, sharing a radio reduces complexity and cost of the node.

Advantageously, sharing a radio between the directional beams reduces the complexity and cost of the node. Furthermore, it may reduce interference on the links because the apparatus can only transmit or receive on any one beam at one time.

The node may further comprise: an apparatus routing traffic between the first and the second coverage areas.

The node may further comprise: an apparatus routing traffic between a first and a second of the at least one backhaul link.

The node may further comprise: a radio for communication over any one of said at least one directional beam in a specified time period.

The first beam pattern may comprise an omni-directional pattern.

The antenna may comprise an omni-directional antenna arrangement.

The antenna may comprise an omni-directional antenna arrangement and a multi-beam antenna arrangement.

A backhaul link may be coupled to any of a plurality of the at least one directional beam.

The first and second coverage areas may share a common communication band.

The node may employ multiple communications bands.

None of the multiple communications bands may overlap.

Multiple communication bands may be associated with at least one of the first coverage area and the second coverage area.

At least one communication band may be shared between the first and second coverage areas.

The node may employ at least two communications bands, for example two communications bands.

The first and second coverage areas may be polarisation diverse.

The antenna may be multi-facetted.

Each facet may comprise at least one antenna.

The second beam pattern may comprise a plurality of directional beams wherein neighbouring beams overlap in the angular domain.

The antenna may comprise at least one Multiple Input Multiple Output antenna.

The antenna may comprise a dual band antenna which is shared between first and second coverage areas.

Advantageously, this reduces the physical size of the apparatus.

The second beam pattern may comprise a plurality of directional beams, and wherein the polarisation of each beam may be independently selected.

The invention also provides for systems and networks for the purposes of communications and which comprises one or more instances of apparatus embodying the present invention, together with other additional apparatus.

In particular, according to a second aspect of the present invention there is provided a communications network comprising at least one node as described above.

The invention is also directed to methods by which the described apparatus operates and including method steps for carrying out every function of the apparatus.

In particular, according to a third aspect of the present invention there is provided a method of providing wireless communications access comprising the steps of: routing communications traffic associated with a subscriber over a wireless access link and over a wireless backhaul link, and an access node to which both the access link and backhaul link are coupled; and in which at least one of the wireless access link and the wireless backhaul link are transmitted over at least one beam of a multi-beam transmission system.

The invention also provides for computer software in a machine-readable form and arranged, in operation, to carry out every function of the apparatus and/or methods. In this context such a program for a computer is also intended to encompass software designed to embody the hardware design of apparatus according to the present invention and used in its design, simulation, and fabrication.

In particular, according to a fourth aspect of the present invention there is provided a program for computer on a machine readable medium, arranged to control a node for a wireless access network, the node comprising: an antenna defining a first wireless coverage area and a second wireless coverage area, wherein the first wireless coverage area extends in a first beam pattern and the second wireless coverage area extends in a second beam pattern, and wherein said second beam pattern comprises at least one directional beam having a direction which is variable.

The invention also provides for a method of providing a communications service over a wireless network according to the present invention.

In particular, according to a fifth aspect of the present invention there is provided a method of providing a subscriber service the method comprising the steps of: providing a node as described above; and routing communications traffic associated with the subscriber service over the node.

Advantageously, such services may be provided either more reliably, more quickly, more efficiently, or more cost-effectively over such networks.

It is also recognised that the present invention may not necessarily limited in its application to access and backhaul arrangements.

According to a sixth aspect of the present invention there is provided a communications node for use in wireless networks, the node comprising: first apparatus arranged to support at least one wireless link on a first wireless network; second apparatus arranged to support at least one wireless link on a second wireless network; and in which at least one of the first and second apparatuses comprises an antenna arrangement arranged to transmit using directional beams. The preferred features may be combined as appropriate, as would be apparent to a skilled person, and may be combined with any of the aspects of the invention.

### BRIEF DESCRIPTION OF THE DRAWINGS

In order to show how the invention may be carried into effect, embodiments of the invention are now described below by way of example only and with reference to the accompanying figures in which:

FIG. 1 shows a schematic diagram of a network in accordance with the present invention;

FIG. 2(a) shows a schematic diagram of an access node in accordance with the present invention;

FIG. 2(b) shows a schematic diagram of antenna coverage in accordance with the present invention;

FIG. 3(a) shows a further schematic diagram of an access node arrangement employing an omnidirectional antenna in accordance with the present invention;

FIG. 3(b) shows a further schematic diagram of an access node arrangement employing a dual-polar antenna in accordance with the present invention.

### DETAILED DESCRIPTION OF INVENTION

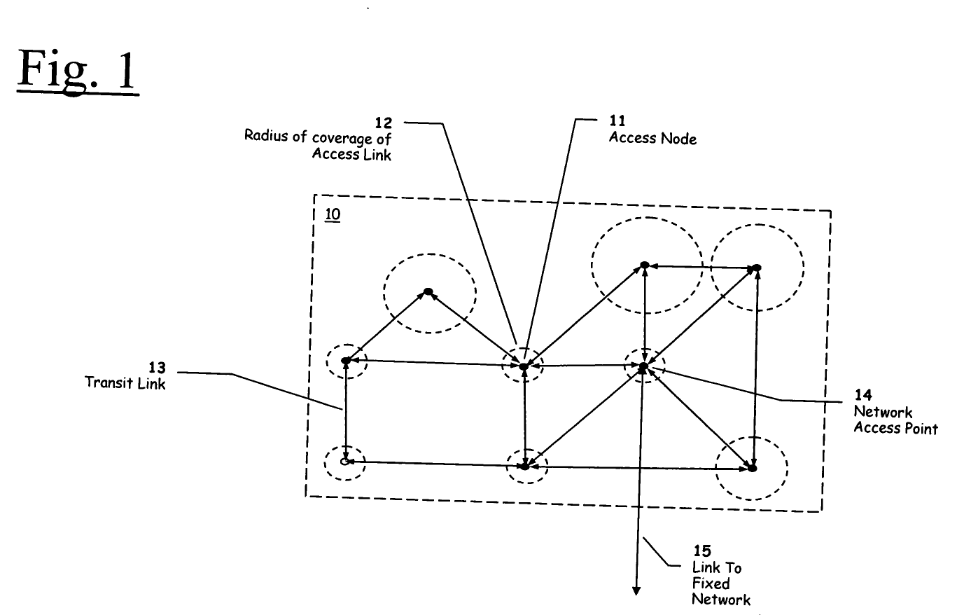

Referring first to FIG. 1, a Wireless Local Area Network (WLAN) Collector Network (WCN) 10 comprises a number of wireless access nodes 11 distributed across an area and coupled by backhaul (or transit) links 13. Such an access node may take the form of a wireless basestation, micro-cellular wireless base station, or any other form of wireless network access point. The nodes may be fully or partially meshed, form a ring, or have any other network connectivity as required. The nodes are connected by the backhaul links to at least one Network Access Point (NAP) 14 which provides a link 15 to the wired network. One NAP can serve many access nodes and the capacity per NAP depends on the number of channels available for the transit link and their reuse factor. The coverage area per NAP is unlimited, but the capacity per NAP will not be. For a viable system, the access nodes must be able to pass data to each other and hence to the NAP, and this is the function of the transit links. Access nodes may also be referred to as Access Points (APs).

Each access node has an associated coverage area and median range 12 within which it also provides wireless access to the network and potentially, either directly or via other nodes in the network, to further networks, whether wired or wireless. The precise size and shape of the coverage area of a particular node may vary.

User traffic may be routed, by the access node, between a subscriber terminal (within the coverage area of a given access node) and a remote terminal or service, along one or more backhaul links.

In the access network part of the system, there is limited potential for frequency reuse. For example the frequency cluster size may be just 3. Contention for the access medium reduces the per-access node throughput. Such contention may arise from:

other access nodes in the WCN;

other mobile terminals in the WCN (particularly if the clusters are large);

contention with other uncoordinated access nodes and mobile terminals in the environment (where the band in use is unlicensed);

and access node defer to interference from Bluetooth transmitters, microwave ovens, etc.

Use of the technique in picocell propagation environments is likely to involve wide angle scatter which limits the benefits of any plane wave directional antenna techniques.

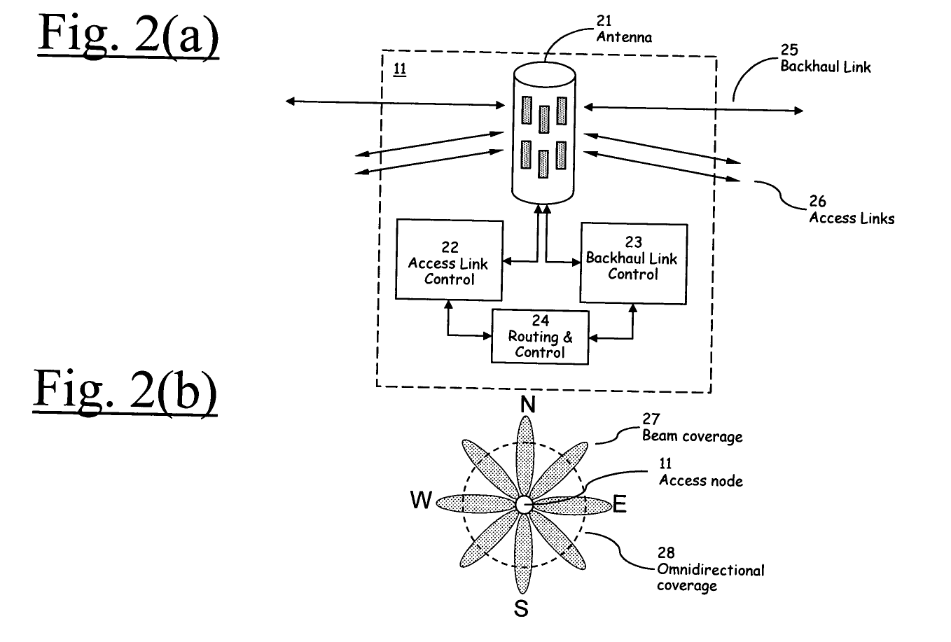

FIG. 2(a) shows such an access node 11, comprising an antenna arrangement (or antenna) 21. An access link control module 22 controls the access link 26 and a backhaul link control module 23 controls the backhaul link. Routing and control, which includes routing of traffic between the access and backhaul links and between two backhaul links, is managed via the Routing and Control module 24. Within a given node, either the access or the backhaul transmission makes use of beams 27 whilst the other transmission system may use omnidirectional transmission 28 or beams (not shown).

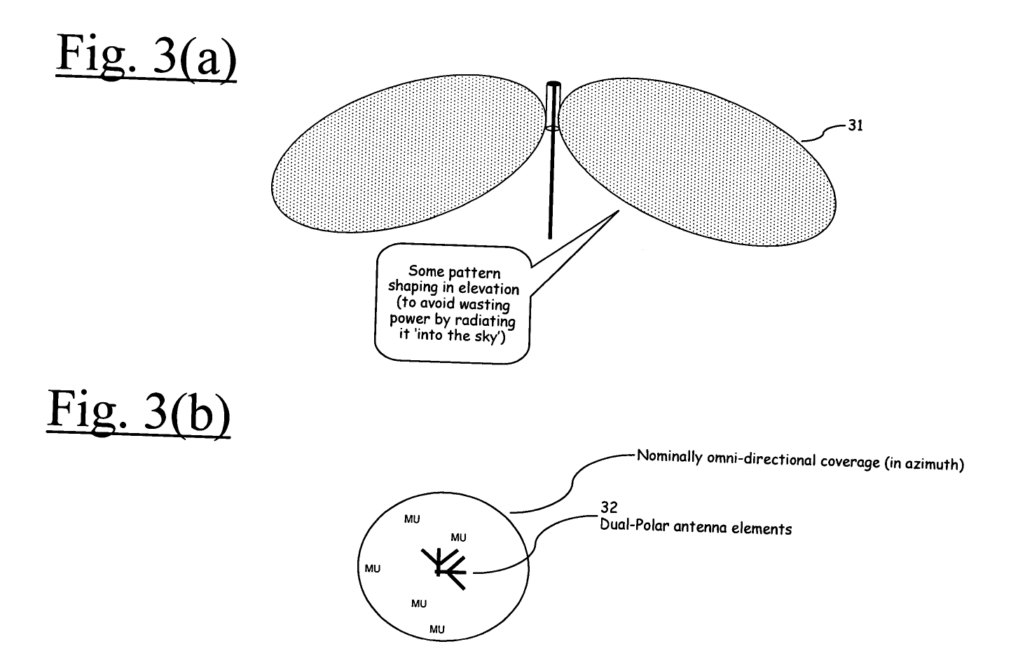

The beams may be fixed directional beams or steerable beams. Beamforming may be used to shape the beams in azimuth and/or in elevation. Variable beamforming circuitry may be used to form beams pointed in any specific direction and may also allow shaping of the beams, if required, e.g. to massage the sidelobes or widen the bandwidth etc. Beams may also be selected or switched.

Where omnidirectional transmission is employed all-round coverage may be obtained by, for example, mounting the antennas on lamp-posts. Referring to FIG. 3(a) some pattern shaping in elevation 31 benefits the link budget through added gain by avoiding wasting power by radiating in unprofitable directions.

The antennas for the access and backhaul transmission may be separate or shared between the two. A multi-faceted multi-beam antenna arrangement, with one or more antennas per facet, is ideal for this purpose. The number of facets may be optimised according to various other design considerations (for example, size, antenna gain, frequency, and beam width).

In designing the backhaul transit links a key objective is extending the range (or reach) of the transit links over known systems. A further aim is managing unwanted interference, for example from distant transit nodes and other co-channel interferers.

The range of the backhaul links can be improved in at least four ways:

antenna gain at the transmitting node

antenna gain at the receiving node

increased transmit (Tx) power compared to a standard AP

increased receive (Rx) sensitivity compared to a standard AP

Improvements to the range of an access link are limited by the user terminal equipment, and so the up and down links can only be improved by either antenna gain, Tx power increases or Rx sensitivity increases at the AP end.

Antenna beam pointing and Mean Effective Gain (MEG) are both issues which may detract from the potential link budget gains. The amount of angle spread may also affect the achievable MEG.

Antenna gain can be provided as a combination of elevation and azimuth directivity, and pointing is only likely to be an issue for azimuth directivity. However azimuth directivity is more desirable than elevation for interference reduction.

The physical size available for the antennas also sets a limit to the gain available in elevation or azimuth.

In a preferred embodiment, access links use 802.11b at 2.4 GHz, and transit links use 802.11a at 5.7 GHz. The path loss laws expected for different propagation scenarios will vary significantly between these two frequency bands. For a cluttered path, the path loss at 5.7 GHz may be significantly greater than at 2.4 GHz, whereas for a line of sight path with a ground reflection, the break point of the two ray model will in fact move out at the higher frequency, and the differential is likely to be less—i.e. only the difference in free space path loss.

The opportunities for antenna directivity are greater at 5.7 GHz, which (as discussed earlier) assists Antenna Array Processing (AAP) in improving either range of transit links through antenna gain, or capacity per NAP through interference reduction. Possible AAP techniques for use on the access and transit links are listed later in the description.

The MAC/PHY layer of the backhaul network may be uncoordinated with contention-based channel allocations (such as IEE 802.11) but this may exhibit limitations as to throughput. Nodes may follow a known Frequency Hopping (FH) plan, but with unsynchronised timing and listen-before-transmit.

Where such networks are deployed in an urban environment, antennas may be deployed below rooftop level, giving rise to a street-canyoning-based anisotropic environment. Signal propagate well down the “canyons” formed by the buildings on either side of the street. Such arrangements exhibit good interference control from buildings, which can help block out potential interferers. Placing antennas below rooftop level helps achieve a steep (R⁴) median pathloss slope to the interfering stations, and careful planned reuse of frequencies and/or polarisations helps minimise unwanted interference from distant nodes. Spatial and/or polarisation filtering may also be applied.

In suburban networks, antennas may be positioned above rooftop level, giving a line of sight (LOS) arrangement. In such systems a narrower angle spread is expected, so plane-wave beam forming works better. Such systems provide good reach for backhaul transit links, but reduced interference control from buildings blocking interferers.

Alternatively, suburban networks may be deployed with antennas below rooftop level. For example, antennas may be mounted on available mounting points such as lamp posts or telegraph poles. In these situations, the angle spread will be less than for antennas mounted above rooftop level, but will also not preclude plane wave beam forming.

The reach of backhaul transit links may be increased by increasing Equivalent Isotropic Radiated Power (EIRP) of the transmissions. Options include increasing the transmit power and/or increasing antenna gain in azimuth and/or increasing antenna gain in elevation (for example a 30° elevation pattern may be achieved with a 2λ antenna height of around 10 cm).

By using beams for the backhaul transmission system, the installation of the access node may be simplified. A new node may be installed without prior knowledge of the location of its neighbouring nodes: the new node can automatically configure itself to use specific beams for backhaul transmission according to detected transmission and reception characteristics. Such auto-configuration may be performed both on installation and on an ongoing basis so that the network may evolve according to whether access nodes are subsequently added or removed from the network. In such an arrangement, the backhaul traffic can be routed via any suitable beam. The use of such auto-configuration greatly reduces installation times, which is a costly part of the network deployment process.

One example of the present arrangement offers an improvement over conventional sectored basestation antenna arrangements in that, whereas in sectored basestation arrangements separate radios are required for each sector, in the present arrangement a single radio may be shared between the beams. The single radio can, therefore, transmit on any one of the beams at a particular time, but not one more than one beam concurrently. This can significantly reduce complexity and cost of the access node. One option is to use one radio for access transmission and another for backhaul, but in each case the radio is used to control transmission across all beams of the associated antenna arrangement.

Both the access transmission system and the backhaul transmission system may share a common transmission band, but preferably the backhaul transmission system and access transmission system use separate bands, thereby enabling more efficient use of the access network bandwidth. Both the access transmission system and the backhaul transmission system may use multiple bands according to local need, whether to support bandwidth requirements or to support, for example, multiple wireless access standards whilst using essentially the same backhaul network.

The coverage areas of the multiple-access access links (for example using IEEE 802.11b at 2.4 GHz) are typically, though not necessarily, non-contiguous. The backhaul links in such an arrangement may operate at approximately 5.7 GHz.

Furthermore, the directional antenna beams provide interference rejection, which mitigates known problems associated with forwarding of ad-hoc backhaul.

The directional (beam) antennas provide increased antenna gain thereby improving the link budget and increasing the system range and/or data rates. The directional antennas also provide interference attenuation allowing a more aggressive frequency re-use across the network, and hence greater system spectral efficiency.

Referring now to FIG. 3(b), the antennas may be dual polarised 32 to provide polarisation diversity. The polarisation of each beam may be independently selected to reduce co-channel interference.

As mentioned above, fast or slowly-adapting spatial and/or polarisation nulls may be used to reduce transit link interference. Other techniques for reducing this interference include coordinating scheduling of transmissions between nodes.

There are a number of AAP options which may be implemented for the access link and the transit link, and examples of these are detailed below and are described elsewhere in the description.

For the access link:

Elevated AP antenna

Fast co-channel interference cancellation (CCIC) techniques. This uses interference nulls, with widely spaced or polarisation diverse AP antennas.

Slow CCIC. This is as above for fast CCIC, but with slow-time weight adaption.

Elevation pattern shaping

Beam steering

Beam switching

For the transit link:

Elevated AP antenna

Polarisation planning

Beam steering

Beam switching

Fast CCIC

Slow CCIC

In a further embodiment, the antenna may be a phase steered array. This provides increased gain and decreased co-channel interference. MIMO technology may also be employed, using multi antenna sub system per facet can be incorporated to drastically improve the distributed wireless backhaul throughput. Multi transmitters and receivers will be required to implement the MIMO technology.

Any range or device value given herein may be extended or altered without losing the effect sought, as will be apparent to the skilled person for an understanding of the teachings herein.

1. A wireless communication node comprising:
an antenna defining a first wireless coverage area and a second wireless coverage area,
wherein the first wireless coverage area extends in a first beam pattern and the second wireless coverage area extends in a second beam pattern, and wherein said second beam pattern comprises at least one directional beam having a direction which is variable.

2. A node according to claim 1, wherein the direction is variable by means of one of beam switching and beam steering.

3. A node according to claim 1, wherein said first coverage area provides at least one wireless link and said second coverage area provides at least one wireless link.

4. A node according to claim 1, wherein said first coverage area provides at least one access link and said second coverage area provides at least one backhaul link.

5. A node according to claim 1 further comprising:
a first radio for communication over said first coverage area; and
a second radio for communication over said second coverage area.

6. A node according to claim 1 further comprising:
a radio for communication over both said first and said second coverage areas.

7. A node according to claim 1 further comprising:
an apparatus routing traffic between the first and the second coverage areas.

8. A node according to claim 4 comprising an apparatus routing traffic between a first and a second of the at least one backhaul link.

9. A node according to claim 1, further comprising a radio for communication over any one of said at least one directional beam in a specified time period.

10. A node according to claim 1, wherein the first beam pattern comprises an omni-directional pattern.

11. A node according to claim 10, wherein the antenna comprises an omni-directional antenna arrangement.

12. A node according to claim 1, wherein the antenna comprises an omni-directional antenna arrangement and a multi-beam antenna arrangement.

13. A node according to claim 4 wherein a backhaul link is be coupled to any of a plurality of the at least one directional beam.

14. A node according to claim 1 in which the first and second coverage areas share a common communication band.

15. A node according to claim 1 employing multiple communications bands.

16. A node according to claim 15 in which none of the multiple communications bands overlap.

17. A node according to claim 15 in which multiple communication bands are associated with at least one of the first coverage area and the second coverage area.

18. A node according to claim 15 in which at least one communication band is shared between the first and second coverage areas.

19. A node according to claim 1 employing at least two communications bands.

20. A node according to claim 19 employing two communications bands.

21. A node according to claim 1 in which first and second coverage areas are polarisation diverse.

22. A node according to claim 1 in which the antenna is multi-facetted.

23. A node according to claim 22 in which each facet comprises at least one antenna.

24. A node according to claim 1 wherein said second beam pattern comprises a plurality of directional beams, and wherein neighbouring beams overlap in the angular domain.

25. A node according to claim 1 wherein the antenna comprises at least one Multiple Input Multiple Output antenna.

26. A node according to claim 1 wherein the antenna comprises a dual band antenna which is shared between first and second coverage areas.

27. A node according to claim 1, wherein said second beam pattern comprises a plurality of directional beams, and wherein the polarisation of each beam is independently selected.

28. A communications network comprising at least one node according to claim 1.

29. A method of providing wireless communications access comprising the steps of:
routing communications traffic associated with a subscriber over a wireless access link and over a wireless backhaul link, and an access node to which both the access link and backhaul link are coupled;
and in which at least one of the wireless access link and the wireless backhaul link are transmitted over at least one beam of a multi-beam transmission system.

30. A program for computer on a machine readable medium, arranged to control a node for a wireless access network, the node comprising:
an antenna defining a first wireless coverage area and a second wireless coverage area,
wherein the first wireless coverage area extends in a first beam pattern and the second wireless coverage area extends in a second beam pattern, and wherein said second beam pattern comprises at least one directional beam having a direction which is variable.

31. A method of providing a subscriber service the method comprising the steps of:
providing a node according to claim 1; and
routing communications traffic associated with the subscriber service over the node.

32. A communications node for use in wireless networks, the node comprising:
first apparatus arranged to support at least one wireless link on a first wireless network;
second apparatus arranged to support at least one wireless link on a second wireless network;
and in which at least one of the first and second apparatuses comprises an antenna arrangement arranged to transmit using directional beams.
